(19) United States
(12) Patent Application Publication
(10) Pub. No.: US 2009/0308667 A1
(43) Pub. Date: Dec. 17, 2009

(54) Drive Unit for Trailers and Caravans

(75) Inventor: Knud Erik Westerdaard, Hadsund (DK)

Correspondence Address: WILLIAM J. SAPONE;COLEMAN SUDOL SAPONE P.C., 714 COLORADO AVENUE, BRIDGE PORT, CT, 06605, US

(73) Assignee: MOVER TECHNOLOGY APS, Hadsund (DK)

(21) Appl. No.: 12/373,871

(22) PCT Filed: Jun. 8, 2007
(86) PCT No.: PCT/DK2007/000277

§ 371 Date: Feb. 9, 2009

(30) Foreign Application Priority Data
Jul. 27, 2006 (DK) PA 2006 01017

(51) Int. Cl. B62D 49/00

(52) U.S. Cl. 180/6.7

(57) ABSTRACT

When, according to the invention, a drive unit for trailers or caravans is arranged such that it comprises a chassis (2) with crawler sections (3), a coupling device (4) having first and second coupling parts (28, 29), said coupling parts (29) being arranged on the hitch triangle (30) behind the normal hitch coupling and behind the nose wheel, and the drive unit additionally comprises means for steering and maneuvering the unit, a good weight distribution is achieved between main wheel and drive unit, so that it is easy to control the placing of the trailer or of the caravan, without having to worry about the risk of colliding with the neighbour or damaging one's own vehicle.

### THE PRIOR ART

The invention relates to a motorized, maneuverable drive unit having crawler sections, said drive unit being intended to be mounted on the hitch triangle of trailers and caravans in particular, said hitch triangle being equipped with a hitch coupling and a nose wheel, wherein the drive unit comprises a chassis with a coupling device having a first coupling part and a second coupling part, said first coupling part being arranged on the chassis, and said second coupling being suitable for mounting in a secured manner on the hitch triangle behind the hitch coupling and the nose wheel, and wherein the drive unit also comprises an energy supply and means for steering and maneuvering the drive unit, and wherein the coupling device additionally comprises a bracket which is arranged on the chassis, and to which the first coupling part is secured, as well as a second bracket which is suitable for mounting on the hitch triangle, and to which the second coupling part is secured, and wherein the coupling parts are adapted to engage each other.

It is well-known that maneuvering with a trailer or a caravan frequently gives rise to problems when the trailer or the caravan is moved the last distance to the location where it is to be parked or be used. The car is frequently disconnected before the trailer or the caravan is completely in place, a matter which may be explained by the fact that the drivers are not experienced in performing the necessary maneuvers in the restricted space at the location, and that he is afraid of damaging his own or the neighbor's caravan. If, at the same time, the support is soft or irregular, the weight of the trailer or of the caravan and the size of the obstacles are often beyond the powers of the drivers to maneuver them into place, resulting in quarrels among the participants.

For years, many attempts have been made at solving this well-known problem, and it has been found that the problem is so great that people are ready to spend even a great sum of money on a useful solution.

The known solutions to the above-mentioned problem may be divided into two main groups, viz. a group of manually operated drive units and a group of motorized units. The manually operated group may additionally be divided into solutions determined by whether the drive unit is mounted on the normal coupling or on the nose wheel, and the motorized group may additionally be divided into solutions determined by whether the drive unit is mounted on the main wheel of the trailer, on the normal coupling or on the nose wheel.

The group of manually operated units includes examples of solutions where a hand crank and a chain drive are used, which may be operated by one person and be coupled to the trailer via the normal coupling, see e.g., the product Avinex on the homepage www.berlynenterprises.com.

Another manual solution is shown in the application US 200310042707, where the drive unit is pivotally mounted on the hitch of the trailer and may be operated with a hand crank, which is in engagement with a nose wheel via a gear.

The published applications GB 2392890 and WO 2004/037567 disclose examples of solutions with hand cranks, and U.S. Pat. No. 2,786,690 A discloses a solution, where a rod by a pumping movement makes a crawler move across the support, and where the drive unit is integrated in the nose wheel suspension.

In the group of motorized solutions, it will be seen in the application GB 2316922 how a friction roller, driven by an electric motor, is arranged in engagement with the main wheel of the trailer or of the caravan, and that the drives may be operated via a wireless unit.

Other motorized solutions are disclosed in the documents U.S. Pat. No. 6,991,050, U.S. Pat. No. 6,945,343, U.S. Pat. No. 4,860,841 and GB 2419575. Here, the drive unit is disposed in connection with the nose wheel in specially adapted nose wheel suspensions.

The document U.S. Pat. No. 3,924,701 A discloses a motorized drive unit having a crawler coupled to the normal hitch coupling. The drive unit is supplied with energy from an external source of power. The document refers to the power current mains. The drive unit may be controlled from a wired remote control. The drive unit may be switched between two speeds. Additionally the drive unit can be equipped with a horizontal beam, which is steered beneath the trailer to engage with the chassis of the trailer behind the hitch triangle.

It has been found that, in many cases, the manual solutions do not meet the expectations which the users have in respect of the products. For one thing, it is difficult to control and apply sufficient forces to the hand crank at the same time, and, for another, it is difficult to make the nose wheel transfer the forces to the support without the wheel slipping on the support. At-tempts at increasing the weight on the nose wheel have not been found effective, and have just meant that even greater forces have to be transferred via the hand crank and the nose wheel.

Among the motorized solutions, the solution where a drive motor is arranged at each of the main wheels, is the most common and the most efficient one. However, the solution is technically complicated and rather expensive and must therefore be mounted at the garage of a trailer dealer. The system is based on battery-driven electric motors, which consume much power, and the batteries are therefore rapidly depleted. Usually, it is necessary to have extra battery capacity and charging equipment to maintain a sufficient charge of the batteries, so that the batteries may be charged by connection to the mains at the camping site.

The solutions where the drive units are mounted in connection with the coupling or with the nose wheel and its suspension, are considerably less expensive and can generally be mounted by the user himself. These solutions, however, are vitiated by the same problem as the manual ones, be-cause the contact face and thereby the friction between the nose wheel and the support is too small for the traction to be transferred to the trailer, in particular if the trailer has been standing on a soft base. It has also been found that the available motor power and battery capacity are too small in several cases. In this connection, it has often been found that the weight resting on the nose wheel or the coupling is too small to ensure a proper friction against the support.

### THE OBJECT OF THE INVENTION

The object of the invention is to overcome these drawbacks, and this is achieved, as stated in the characterizing portion of claim 1, by constructing the drive unit so that it comprises a chassis with a coupling device having a first coupling part and a second coupling part, said first coupling part comprising an outer pipe and an inner pipe, said inner pipe being pivotally connected with the chassis by a bolt and a bracket, said outer pipe being mutually displaceable along their common central axis, and said second coupling part comprising a bracket having at least two fixing brackets, said fixing brackets being adapted to be mounted on the hitch triangle on each of the forwardly pointing side member profiles, and which are additionally interconnected by an adjustable profile for absorbing pressure and torsion impacts applied to the hitch triangle by the drive unit.

When, as stated in claim 1, the drive unit is equipped with a coupling device which comprises first and second coupling parts, said first coupling part being arranged on the chassis of the drive unit, and said second coupling part being arranged on the hitch triangle in a position disposed behind both the normal hitch coupling and the nose wheel suspension, an advantageous weight distribution is achieved between main wheel and drive unit. The crawler sections provide a large surface contact and thereby great friction between the drive unit and the support, so that it is possible to transfer great traction forces to the trailer or the caravan. Further, the crawler sections give good maneuvering options in cooperation with the steering and maneuvering means and the incorporated energy supply.

When, as stated in claim 1, the coupling device is constructed so as to comprise a bracket secured to the top of the chassis, to which the first coupling part is secured, as well as a second bracket arranged on the hitch triangle, to which the second coupling is secured, and the coupling parts are adapted to engage each other, it is ensured that the drive unit may be coupled with a trailer or a caravan in a simple manner without having to make radical changes of the existing structure, so that the mounting may be carried out by others than skilled persons.

When, as stated in claim 1, the first coupling pad is constructed so as to comprise an inner pipe and an outer pipe, said inner pipe being connected with the chassis by the bracket, said outer pipe being rotatable about the central axis of the pipe, said pipes being mutually displaceable along their common central axis, a coupling element is achieved, which allows the drive unit to pivot, and which is capable of absorbing vertical displacements of the support.

When, as stated in claim 1, the bracket for the hitch triangle is adapted to comprise the second coupling part as well as two fixing brackets for fixing to the side members of the hitch triangle as well as an adjustable pipe profile arranged between the fixing brackets, and the second coupling, a coupling element is achieved, which is easily mounted and which is capable of absorbing pressure and torsion impacts applied to the triangle by the drive unit.

When, as stated in claim 2, the inner pipe is provided with a bearing bushing for attachment to the chassis and with a collar bushing which is adapted to the internal dimensions of the outer pipe, as well as a plurality of spacer elements, and when the outer pipe is provided with a coupling plate which fits in the second coupling part, and the coupling plate is additionally provided with a spring-loaded locking device, a first coupling part is achieved, which is capable of absorbing pressure loads and lateral loads when the drive unit is being maneuvered, and which is adapted to coupled and locked to the second coupling part.

When, as stated in claim 3, the second coupling part is provided with a guide for receiving the coupling plate from the first coupling part, and the guide is defined upwardly by the lower plate part of the fixing bracket, and the plate part is provided with a locking hole and a wedge-shaped milled portion directed toward the locking hole, it is ensured that it is possible to couple the drive unit together with the hitch triangle by moving the coupling plate with the locking device into the guide, and that the locking pawl is pressed back by the wedge during the insertion and is released only when the pawl is at the locking hole.

When, as stated in claim 4, the outer side of the crawler belt is provided with a strong friction-generating pattern of plastics, a large contact area is achieved between belt and support with a very great friction.

When, as stated in claim 5, the steering and maneuvering means are constructed as a remote control unit which allows wireless as well as non-wireless control via a motor control system, it is ensured that the drive unit may be operated in several ways, thereby making it possible to apply both methods depending on the situation concerned.

Finally, it is expedient, as stated in claim 6, to construct the chassis with an enclosure for the storage of a battery pack as well as the stated electrical circuit modules. Moreover, it is expedient to adapt the top of the chassis-for the mounting of a solar cell module and to adapt the end plate of the chassis for the mounting of a charging plug, and it is likewise expedient to adapt the electronic circuits to be able to cooperate with each other, and to base the wireless signals on coded infrared light or coded signals in the radio frequency range, and to provide the motor control circuit with a soft start function.

### THE DRAWING

Preferred exemplary embodiments will be described more fully below with reference to the drawing, in which

FIG. 1 shows a perspective view of the drive unit according to the invention with a coupling device mounted thereon,

FIG. 2 shows a perspective view of a crawler section,

FIG. 3 shows the arrangement of the drive unit,

FIG. 4 shows a perspective view of the drive unit mounted on the side members of the hitch triangle,

FIG. 5 shows a sectional view of the coupling parts,

FIG. 6 shows a view of the bracket to be mounted on the hitch triangle, and

FIG. 7 shows a bottom view of a coupling part mounted on the hitch triangle.

### DESCRIPTION OF THE EXEMPLARY EMBODIMENTS

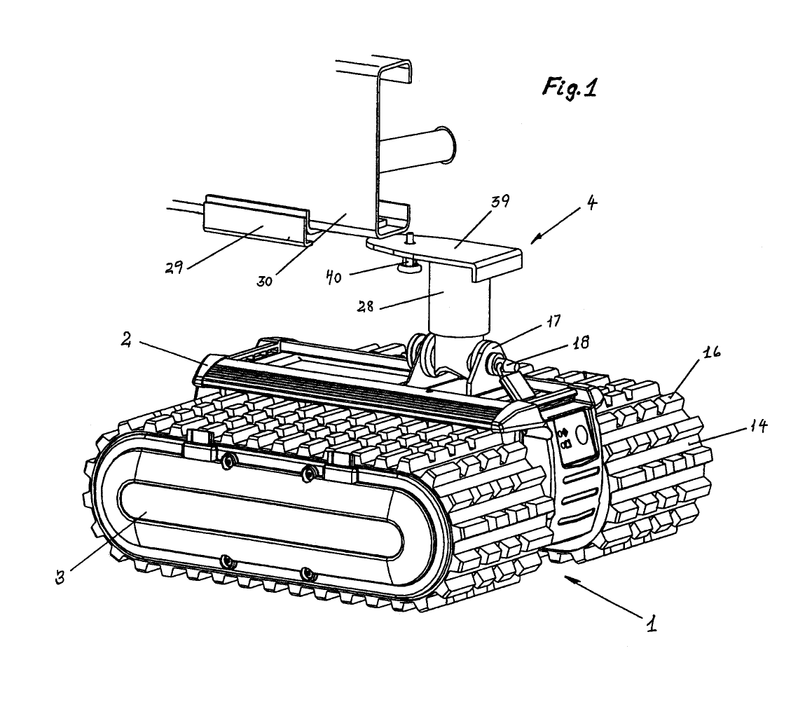

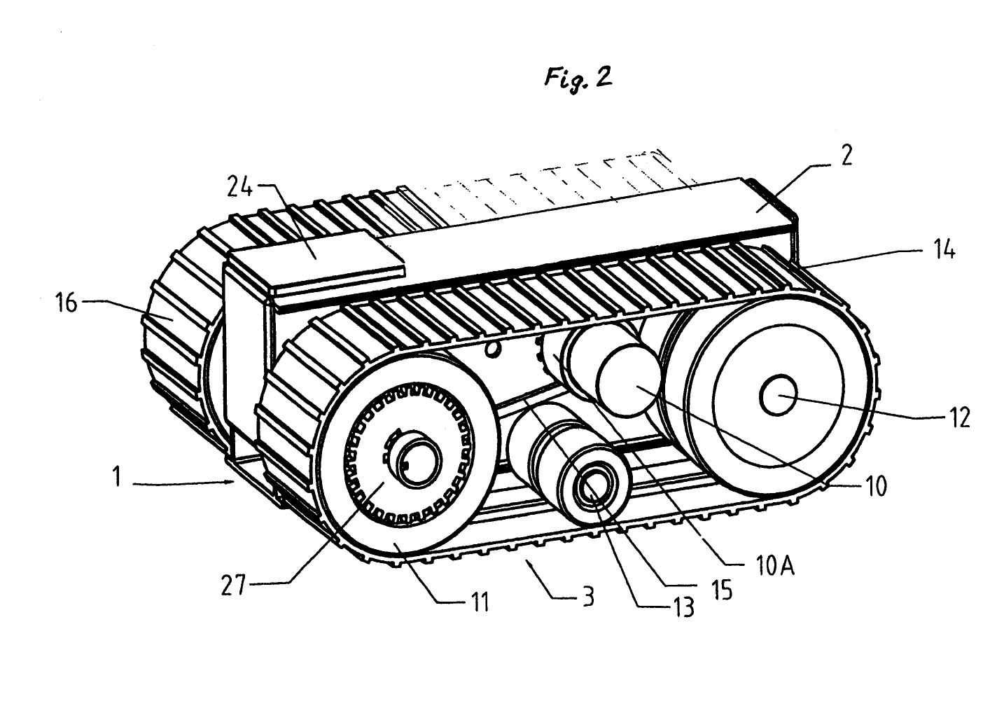

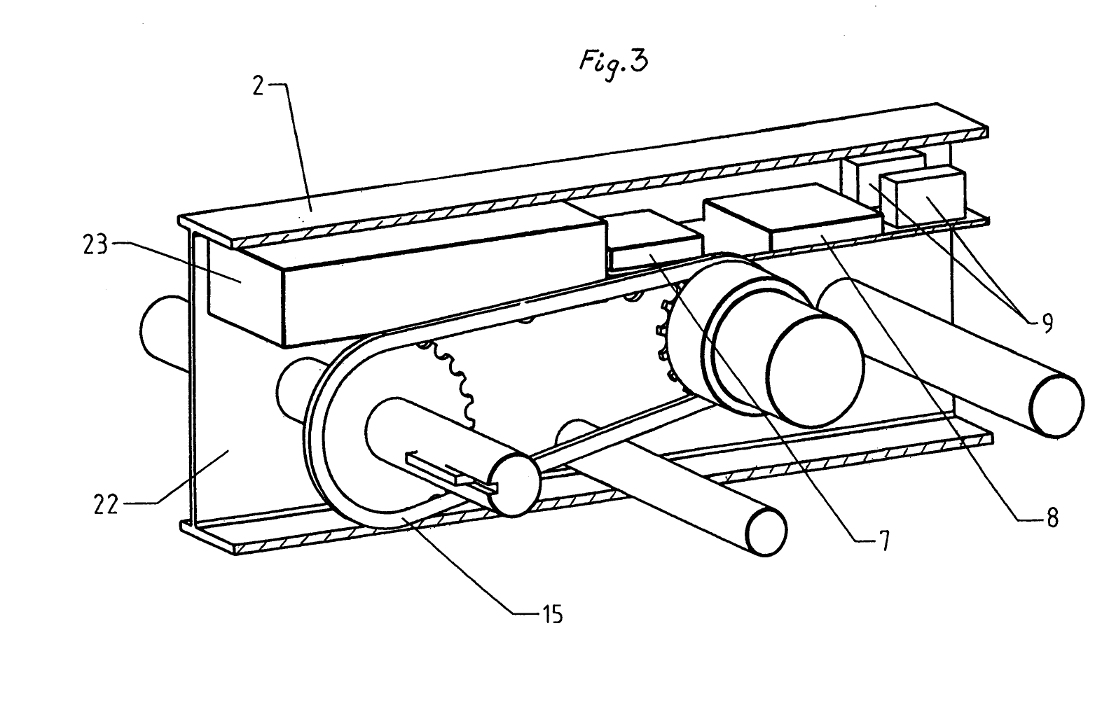

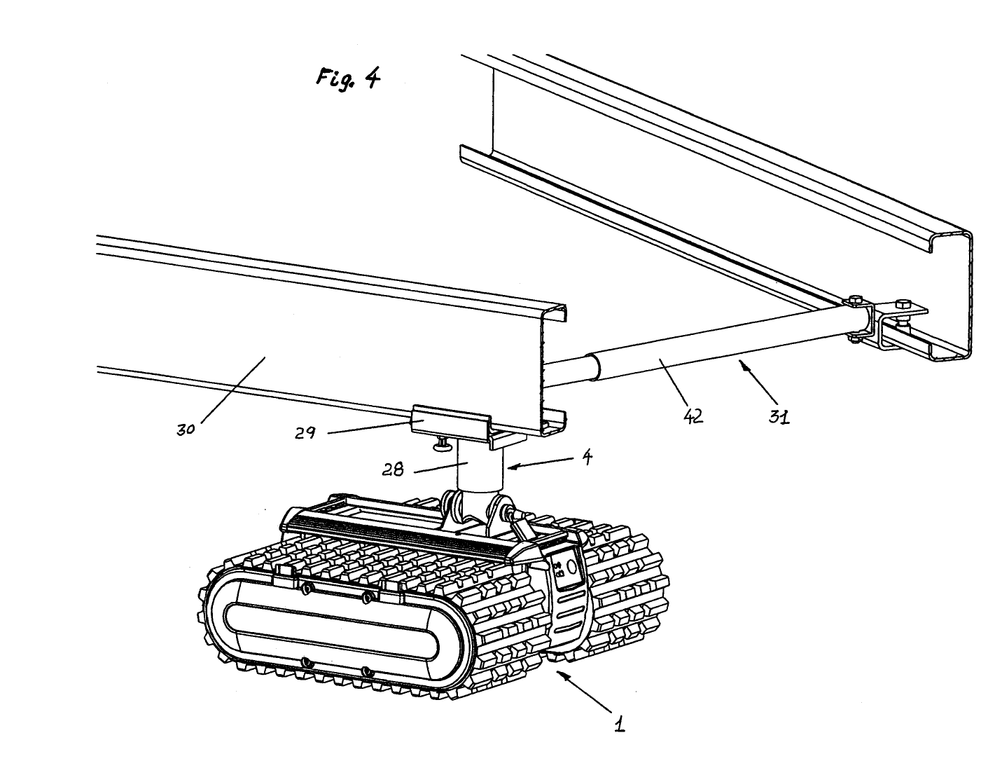

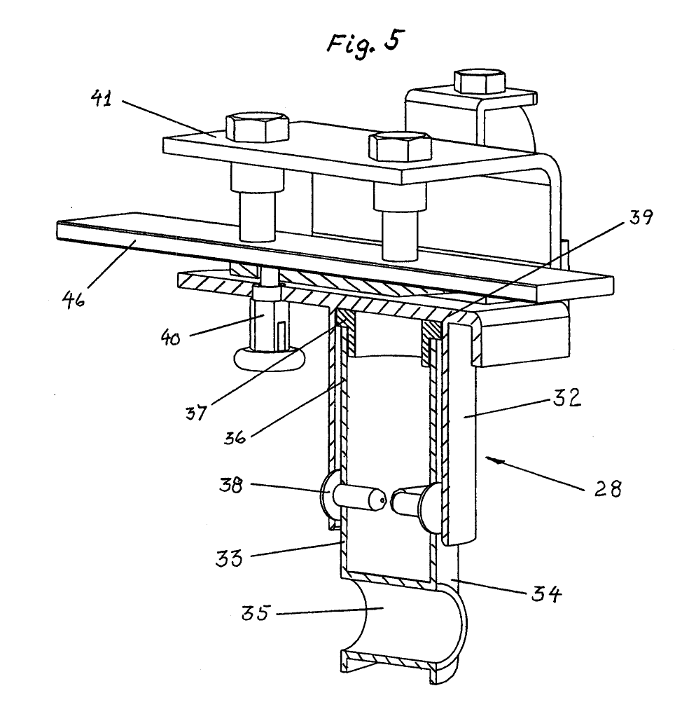

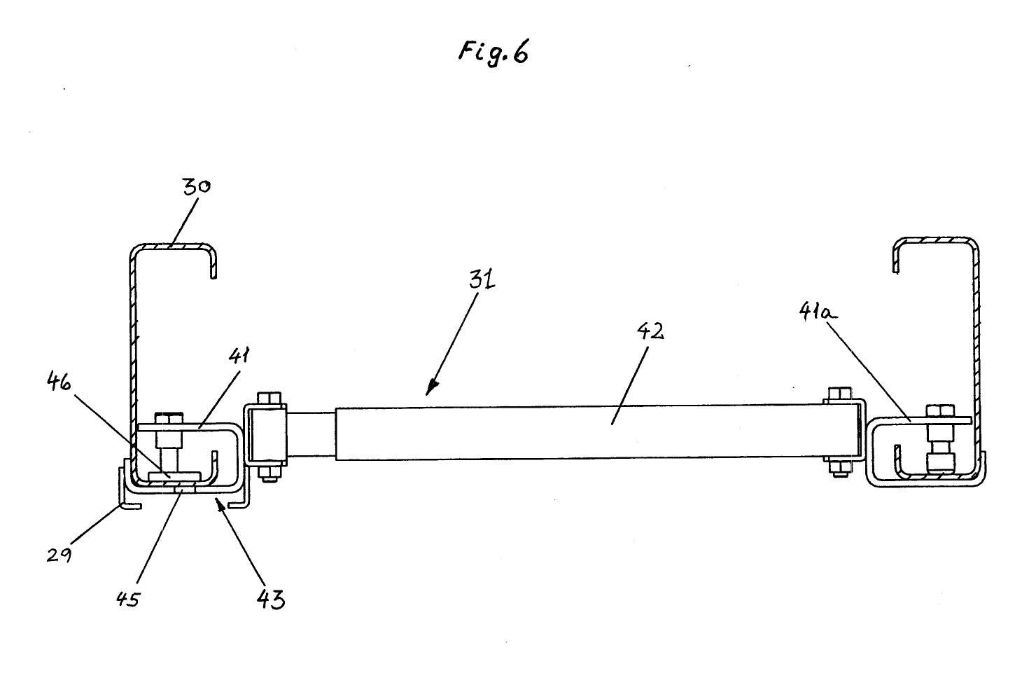

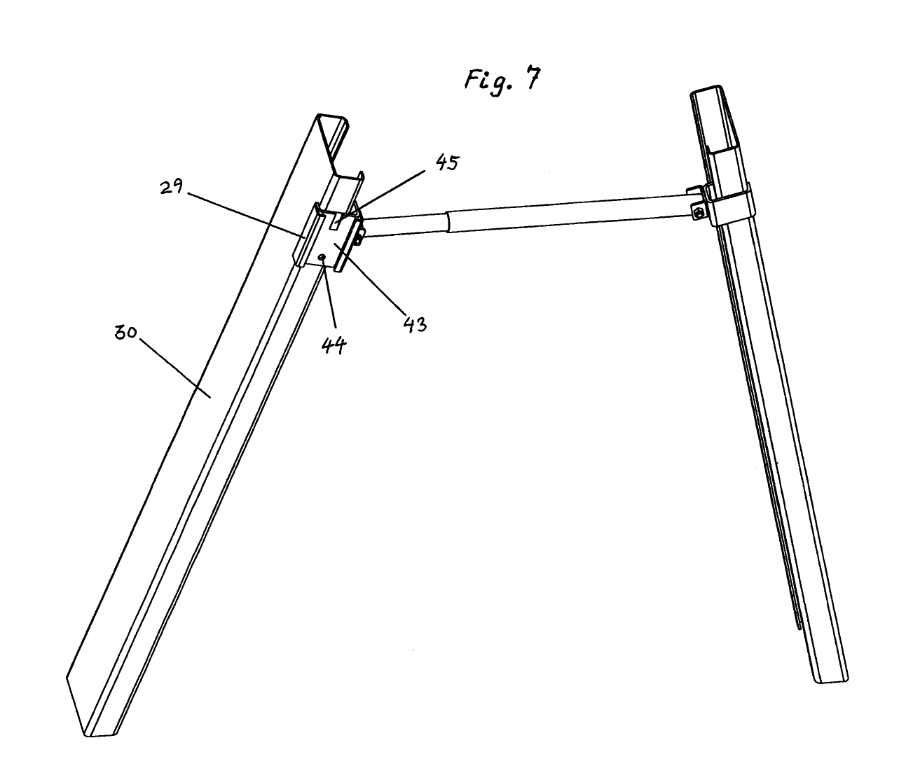

Exemplary embodiments shown in FIG. 1, FIG. 2, FIG. 3, FIG. 4, FIG. 5, FIG. 6 and FIG. 7, respectively, will be described below.

FIG. 1 shows how the drive unit 1 is constructed, and the main components which are included. The drive unit 1 is based on a chassis 2 made of a profile on which crawler sections 3, a coupling device 4 for coupling to the hitch triangle 30 of the trailer or of the caravan, as well as means for steering and maneuvering the drive unit may be mounted. The profile is dimensioned to be capable of supporting the load which is normally applied to the hitch coupling. The profile may be extruded, but may also be welded. The material may be aluminum or steel.

FIG. 2 shows that the crawler sections 3 are mounted on each side of the chassis 2. The crawler sections 3 comprise a motor 10 with a gear 10a which is in engagement with a driving wheel 11, an idling wheel 2, at least one support wheel 13 and a crawler belt 14 via a drive connection 15. As shown in FIG. 3, the drive connection may be established according to known principles and with known components, where chain wheel and chain is one of the solutions, but it may also be established as a toothed belt connection or a V-belt connection. A preferred embodiment is a chain wheel drive.

The driving wheel 11 is provided with a spring-loaded coupling configured to lock the drive shaft with the drive wheel e.g. by a set of coupling means, which may be displaced in an axial direction, and which may be released manually by a grip 27, so that the belt may move freely and serve as a traditional nose wheel, if the energy supply should fail.

The motor 10 is an electric motor with a gear 10a mounted thereon. The motor operates on DC current and is fed from a 12 volts DC voltage source. The motors can supply a torque of 25 to 70 Nm. The gear 10a, which is constructed to cooperate with the motor 10, is dimensioned to reduce the number of revolutions about 200 times. The gear is of a known structure and may be of a type having an offset or angled input shaft and output shaft, or a type where the input shaft and the output shaft are positioned in extension of each other.

The crawler belt 14 is made of a flexible material, such as e.g. plastics or rubber, and the outer side of the belt is equipped with a pattern 16 which is configured so as to provide great friction between belt and support, whereby slipping is reduced to the greatest extent possible. The belt 14 runs around the wheels 11, 12, and 13, at least one support wheel 13 ensuring that the traction forces are transferred to the support to the greatest extent possible by pressing the belt between the wheels 11 and 12 tightly against the support so that the contact face against the support is as great as possible.

A coupling device 4 is arranged on the top of the chassis 2, said coupling device being intended to couple the drive unit 1 together with the hitch triangle 30 of the trailer or of the caravan. The coupling device 4 comprises the coupling part 28 and the coupling part 29, said coupling parts being adapted to engage each other. The coupling part 28 is connected with the chassis by the bracket 17 and the bolt 18. The coupling part 29 is connected with the hitch triangle 30 by the bracket 31.

Constructing the coupling device 4 in this manner provides a technical solution which is simple, and which can be mounted by persons without any special training in the construction and building of trailers or caravans.

FIG. 5 shows the structure of the coupling part 28. It comprises an outer pipe 32 and an inner pipe 33. The outer pipe is provided with a coupling plate 39 on which a locking device 40 is arranged. The coupling plate is configured with a slight taper, so that it may easily be introduced into the guide 43 on the coupling part 29. The locking device 40 is provided with a spring and a rotatable finger grip. The lock is opened by pulling the finger grip, and it is held in the open position by rotating the finger grip through one quarter of a rotation.

The free end 34 of the inner pipe 33 is provided with a bearing bushing 35, so that the pipe may be secured pivotally to the chassis 2 by means of the bracket 17 and the bolt 18. Hereby, irregularities transversely to the driving direction may be absorbed without causing any problems to the coupling. The bolt 18 may be locked by a padlock. Further, the inner pipe 33 is provided with a plurality of spacer elements 38 which fill the space between the inner pipe and the outer pipe. The elements 38 are made of metal or plastics and serve the purpose of reducing the friction between the pipes and of transferring lateral forces between the pipes. In addition, the inner pipe is provided with a collar bushing 37 which is to absorb the pressure impact from the trailer, and which is to allow mutual rotation of the pipes 32 and 33. Moreover, the pipes are displaceable along their common central axis, so that they can absorb the differences in height which occur during coupling-together and during driving.

FIG. 5 to FIG. 7 show how the coupling part 29 is constructed and arranged on a hitch triangle 30. The coupling part 29 forms part of the bracket 31, which is fixed to the side members of the hitch triangle 30 by the fixing brackets 41 and 41a. The bracket 31, and thereby the coupling part 29, is mounted on the hitch triangle 30 in a position which is between the nose wheel suspension and the main wheel of the trailer. Placing the coupling there results in an increased pressure on the drive unit 1 and thereby a better friction relative to the support. Relative to the pressure on the hitch coupling or the nose wheel, the pressure is increased by 45-55%. Hereby, it is possible to maneuver the trailer by means of the drive unit under all conditions.

A profile 42 is disposed between the fixing brackets 41 and 41a, said profile being adjustable depending on the position on the hitch triangle 30. The profile 42 serves the purpose of absorbing torsion loads which might occur during maneuvering. Further, a flat bar profile 46 is arranged between the screws for the fixing bracket 41 and the side member of the hitch triangle in order to stiffen the side member and the coupling bracket.

The fixing bracket 41 is provided with the coupling part 29. The coupling part 29 consists of a guide 43 and the lower plate part of the fixing bracket 41. The lower plate part is formed with a locking hole 44, which fits the locking tongue on the locking device 40, as well as a wedge-shaped milled portion 45 which serves the purpose of pressing the locking tongue book during the insertion into the coupling.

When the coupling parts 28 and 29 are constructed in this manner, it is possible to couple the drive unit and the trailer together merely by maneuvering the drive unit with the coupling plate 39 into the guide 43.

The drive unit is equipped with means for directional steering. Thus, the means comprise a remote control unit. The remote control unit is adapted for wireless communication, and it is for electrical control of the drive unit via a motor control system, which is capable of controlling all functions in connection with start and stop, speed, forwards and rearwards as well as turning to the right or the left. The control units are also available in a non-wireless embodiment.

The chassis 2 is additionally adapted to contain the control system and the energy supply for steering and maneuvering the drive station. FIG. 3 shows a sectional view of the drive unit. It is shown here that the chassis is provided with an enclosure 22 in which the battery 23, a charging circuit 7 for the battery, an electrical motor control system 8 and a communications circuit 9 are positioned. Further, a solar cell module 24 (see FIG. 2), which is an energy supply for the charging circuit 7, is arranged on the top of the chassis, and a power plug for the connection of an external charging circuit to the battery is mounted on the end plate of the chassis.

The battery 23 consists of a rechargeable battery having a great capacity of at least 8000 mAh. Lithium batteries are a preferred type. The charging circuit 7 is dimensioned to cooperate with the battery 23 and the solar cell module 24. The solar cell module has the dimensions 150×70 mm and provides a current of 65 mA at a voltage of 17.4 vdc. The energy supply provides for 30 minutes' maneuvering with the trailer. The external charging circuit provides 1 A at a voltage of 10-20 vdc.

The motor control circuit 8 is arranged with soft start and to be able to control at least two motors individually and to cooperate with the communications circuit 9, which is adapted to cooperate with the remote control units. The communication takes place wirelessly and is based on coded infrared light or coded radio signals, so that signals from foreign control units cannot activate the drive station.

Coupling together of trailer and drive unit takes place by first lowering the nose wheel so that it lifts the hitch triangle slightly. Then, the drive unit is driven into position at the coupling location by the remote control unit. The coupling plate is lifted slightly by the hand so that it catches the guide. The drive unit is then driven into the guide by the remote control. The wedge-shaped milled portion itself pushes the locking tongue back, so that the coupling plate may be homed completely, said locking tongue being pressed into the locking hole by the spring element in the lock. The nose wheel is then pulled back so that the drive unit receives the entire load, and maneuvering of the trailer may now be performed with the remote control unit.

Disconnection is performed by lowering the nose wheel again so that it takes over the load. Then, the lock is released manually, and the drive unit may now be driven out of engagement with the coupling part on the hitch triangle.

1. A motorized, maneuverable drive unit having crawler sections with crawler belts, said drive unit being adapted to be mounted on a hitch triangle of trailers and caravans in particular, said hitch triangle being equipped with a hitch coupling and a nose wheel, wherein the drive unit (1) comprises a chassis (2) with a coupling device (4) having a first coupling part (28) and a second coupling part (29), said first coupling part being arranged on the chassis, and said second coupling part being suitable for mounting in a secured manner on the hitch triangle (30) behind the hitch coupling and the nose wheel, and wherein the drive unit also comprises an energy supply and means for steering and maneuvering the drive unit, and wherein the coupling device (4) additionally comprises a bracket (17) which is arranged on the chassis (2), and to which the first coupling part (28) is secured, as well as a second bracket (31) which is suitable for mounting on the hitch triangle (30), and to which the second coupling part (29) is secured, and wherein the coupling parts (28, 29) are adapted to engage each other, characterized in that the first coupling part (28) comprises an outer pipe (32) and an inner pipe (33), said inner pipe being pivotally connected with the chassis (2) by a bolt (18) and the bracket (17), said outer pipe being rotatable about the central axis of the pipe, said pipes being mutually displaceable along their common central axis, and that the second coupling part (29) comprises a bracket (31) having at least two fixing brackets (41, 41a), said fixing brackets being adapted to be mounted on the hitch triangle (30) on each of the forwardly pointing side member profiles, and which are additionally interconnected by an adjustable profile (42) for absorbing pressure and torsion impacts applied to the hitch triangle by the drive unit.

2. A drive unit according to claim 1, characterized in that the free end (34) of the inner pipe is provided with a bearing bushing (35) for coupling to the bracket (17), and that the opposite end (36) of the inner pipe is provided with a collar bushing (37) which is adapted to the internal diameter of the outer pipe, and that it is additionally provided with one or more spacer elements (38), and that the outer pipe is provided with a coupling plate (39) which fits the second coupling part (29), and that the coupling plate is provided with a spring-loaded locking device (40).

3. A drive unit according to claim 1 or 2, characterized in that the coupling part (29) comprises a guide (43) for receiving the coupling plate (39), and that the guide is defined upwardly by the lower plate part of the fixing bracket (41), said plate part being provided with a locking hole (44) and a wedge-shaped milled portion (45) directed toward the locking hole.

4. A drive unit according to claim 3, characterized in that the outer side of the crawler belt (14) is provided with a strong, friction-generating pattern (16) of plastics or rubber.

5. A drive unit according to claim 1, characterized in that the steering and control means comprise a wireless as well as a non-wireless connection between the motor control system (8, 9) and a remote control unit.

6. A drive unit according to claim 1, characterized in that the chassis (2) additionally comprises an enclosure (22) for a battery (23), a charging circuit (7) for the battery, an electrical motor control circuit (8) and an electrical communications circuit (9) for wireless control of the drive unit, that a solar cell module (24) is additionally arranged on the top plate of the chassis, that the charging circuit (7) is adapted to cooperate with the battery (23) and with the solar cell module (24), that the end plate of the chassis is provided with a charging plug for an external charging unit, that the motor control circuit (8) is provided with a soft start function and is adapted to control at least two motors individually and to cooperate with the communications circuit (9), and that the communications circuit is adapted to operate with wireless signals based on coded, infrared light or coded signals in the radio frequency range or with non-wireless signals.

7. A drive unit according to claim 2, characterized in that the coupling part (29) comprises a guide (43) for receiving the coupling plate (39), and that the guide is defined upwardly by the lower plate part of the fixing bracket (41), said plate part being provided with a locking hole (44) and a wedge-shaped milled portion (45) directed toward the locking hole.

8. A drive unit according to claim 7, characterized in that the outer side of the crawler belt (14) is provided with a strong, friction-generating pattern (16) of plastics or rubber.
